(19) United States
(12) Patent Application Publication
(10) Pub. No.: US 2005/0232162 A1
(43) Pub. Date: Oct. 20, 2005

(54) METHOD AND SYSTEM OF MANAGING EVENT INFORMATION WITH AN ELECTRONIC FORM SYSTEM

(76) Inventors: Nick Chen, Taipei Hsien (TW); Paul Lai, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,134

(22) Filed: Feb. 4, 2005

(30) Foreign Application Priority Data
Apr. 20, 2004 (TW) 093110968

(51) Int. Cl. H04L 1/00

(52) U.S. Cl. 370/252; 370/465

(57) ABSTRACT

A method of managing event information includes receiving event information, identifying the priority of the event information when receiving the event information, setting a timing for transmitting the event information based on the priority of the event information, and transmitting the event information at a time indicated by the timing.

### BACKGROUND OF INVENTION

1. Field of the Invention

The present invention relates to an electronic managing method and a system thereof, and more particularly, to a method of managing event information according to an electronic form system.

2. Description of the Prior Art

A traditional form is often used for a standard procedure including purchasing, warehousing, receiving, filing, stamping, and delivering. Such procedure is very complicated, and in addition, if a company's name changes, paper forms which have been printed become useless so that much unnecessary cost is incurred. Furthermore, because forms are filled and read by humans, not only is the beauty and consistency of forms important, but also reading mistakes can occur due to human error. Besides, as mentioned above, the cost of printing paper forms can be very high.

Fortunately, following the rapid development of the Internet and information technology, more and more corporations utilize e-systems to replace traditional communication systems for such procedures as asking prices, telling prices, ordering goods, purchasing, staff hiring, staff asking for official leave, staff asking for leave, etc. The procedures of the above-mentioned communication in a normal company must include examination and approval by at least one manager. The corresponding forms can be very complicated and confusing. Therefore, many companies utilize a corresponding e-form to simplify these complicated procedures. Time durations of delivering forms, checking forms, and managing forms are reduced because of the e-system advantages of high efficiency, easy tracking and managing. Therefore, not only are resources saved, but also the efficiency of the company is higher.

The prior art e-form system allows the staff to fill out the application form through a browser window, and the examination and approval of the e-forms can be performed through e-mail. It is similar to writing e-mail, reading e-mail, and setting the address of the receiver so that all the application events are revealed. E-forms which are used for, for example, applying a meeting, examining and approving an application, and business analysis, are capable of being executed immediately so that the paper cost is saved, the efficiency is raised, and environmental resources are saved.

Although the staff can send their requests to managers through e-mail and can be approved by the managers, managers may already receive too much unclassified e-mail which disturbs the managers. Furthermore, this also implies that even if an essential form is included inside the e-mail, the manager maybe ignore the e-mail because of having too many other e-mails to attend to. Therefore this may cause the inefficiency of checking e-mail, and furthermore important items may be ignored. For example, for a manager of a company, a lot of e-mail are received may be for requesting sick leave, requesting official leave, applying for purchase of a new computer, or notifying that an emergency meeting will start in 15 minutes. Apparently, the emergency meeting is more essential, but if all of the e-mail is received at the same time, the manager may deal with the official leave request first instead of the more important emergency meeting. Therefore, the manager cannot easily manage all the e-mail in a proper way according to the importance of the e-mail.

### SUMMARY OF INVENTION

It is therefore a primary objective of the claimed invention to provide an electronic managing method and an electronic form system thereof to solve the above-mentioned problem.

According to an exemplary embodiment of the claimed invention, a method of managing event information comprises receiving event information, identifying a priority of the event information, setting a timing of transmitting the event information according to the priority of the event information, and transmitting the event information at a time indicated by the timing.

An electronic managing system of managing event information comprises a database for storing rules for identifying a priority of event information and rules for setting a transmitting timing according to different priorities, a receiving device for receiving the event information, a processing device for analyzing contents of the event information and setting the transmitting timing according to the contents and the database, a buffer for storing the event information before a time indicated by the transmitting timing, and a transmitting device for transmitting the event information at the time indicated by the transmitting timing.

It is an advantage of the present invention that the priority of the event information is arranged according to the importance of different event information so that the event information can be processed according to the priority.

It is another advantage of the present invention that a copy is sent to the source that transmitted the event information for inquiring after receiving or transmitting the processing notifying of the event information.

It is another advantage of the present invention that the present invention system is capable of being combined with other software such as e-mail software or messaging software. The present invention system only has to add a database to store rules of determining importance of different event information and rules of deciding corresponding transmitting timing, and a processing device (such as hardware, software, firmware) for setting according to the rules in the database. The event information is transmitted at the transmitting timing after being set to be transmitted at the transmitting timing. It can be transmitted through present e-mail software or messaging software so that the cost for inventing software is saved.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of an electronic managing system according to the present invention.

FIG. 2-FIG. 5 are several possible flow charts of the present invention electronic managing system manages event information.

FIG. 6 is a relationship chart after the present invention electronic managing system processes event information.

FIG. 7 is a diagram of another electronic form system according to the present invention.

### DETAILED DESCRIPTION

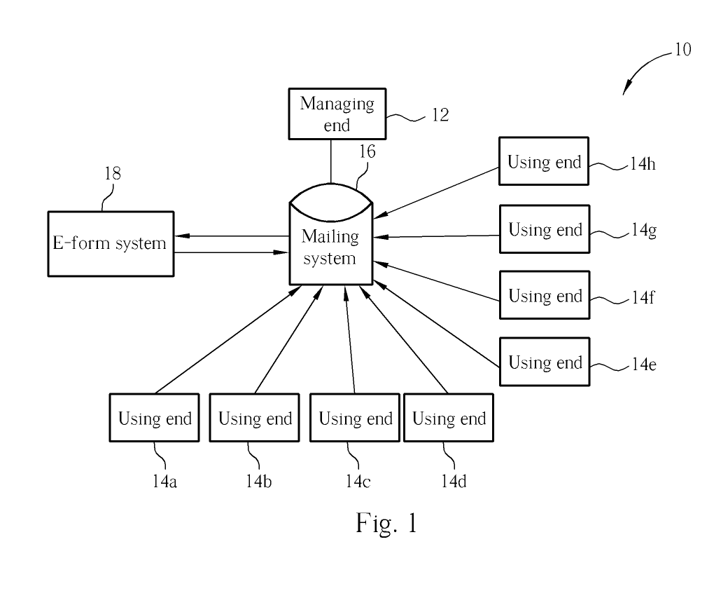

Please refer to FIG. 1, which is a diagram of an electronic managing system 10 according to the present invention. The electronic managing system 10 comprises a managing end 12, a plurality of using ends 14a-14h, a mailing system 16, and an e-form system 18. The managing end 12 communicates with the using ends 14a-14h through the mailing system. The preferred embodiment utilizes the Microsoft® Outlook® mailing system, but utilizing other mailing systems is still in the spirit of the present invention.

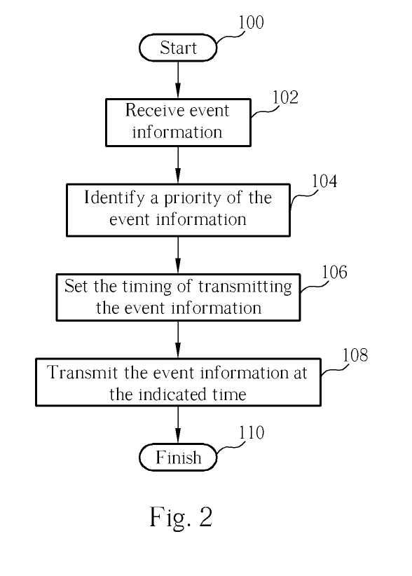

Please refer to FIG. 2, which is a flow chart of the electronic managing system managing event information. The steps are illustrated as follows.
Step 100: start;
Step 102: receive event information;
Step 104: identify a priority of the event information when receiving the event information;
Step 106: set the timing of transmitting the event information according to the priority of the event information;
Step 108: transmit the event information at the time indicated by the timing; and
Step 110: finish.

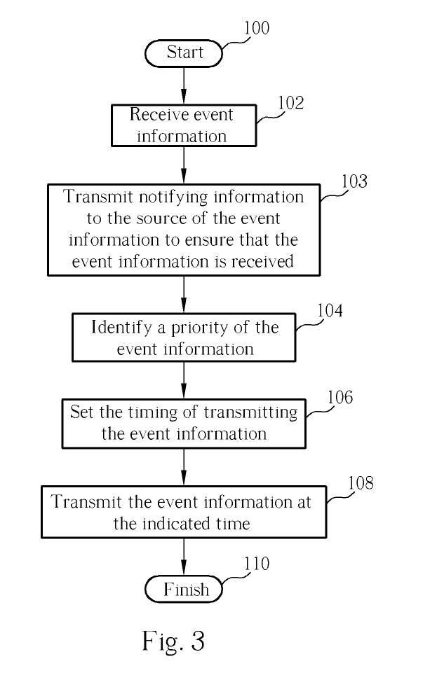

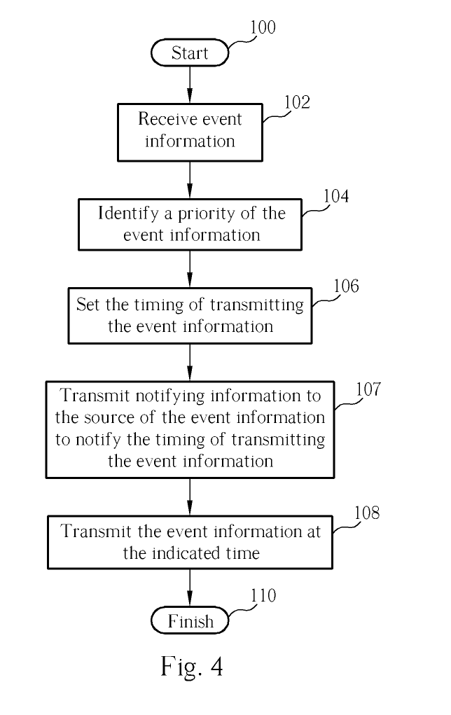

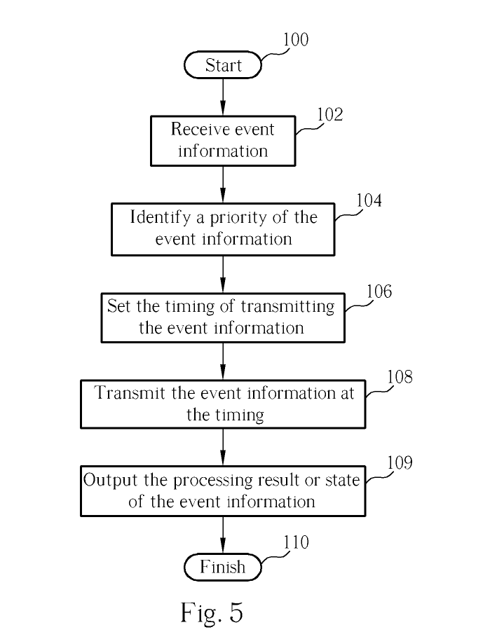

Please refer to FIG. 3. Another step 103 between the steps 102 and 104 is used to transmit notifying information to the source of the event information to notify that the event information is received. Similarly, please refer to FIG. 4, another step 107 between steps 106 and 108 is disclosed. Step 107 is used to transmit the notifying information to the source of the event information to notify the timing of transmitting the event information. Please refer to FIG. 5, another step 109 between steps 108 and 110 is disclosed. Step 109 is used to receive the notifying information from the managing end such as the response of receiving the event information, the processing state, or the processing result of the event information.

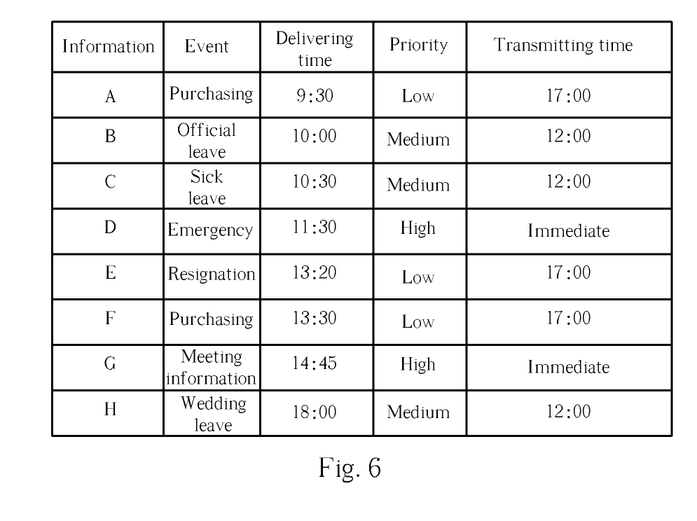

For detailed illustration, a company using an electronic managing system 10 is taken as an example. The user of managing end 12 can be managers of the company. The users of using ends 14a-14h can be employees of the company. The electronic managing system 10 is utilized to allow the managing end 12 to manage the whole company through electronic methods. Please refer to FIG. 6, which is a relationship chart after the present invention electronic managing system processes event information. We assume that the user of the using end 14a transmitted an application of purchasing 30 LCD displays (event information A) to the manager of the managing end 12 at 9:30 through the Microsoft® Outlook® mailing system. At that time, the event information A was transmitted to the mailing system 16, and the e-form system 18 classified and stored the contents and the transmitting time of the event information A. Because the e-form system 18 identified the priority of the event information A as “low”, and we assume the e-form system 18 transmits low-priority event information at 17:00 (5:00 pm) every afternoon, so that the timing of transmitting event information A was set as 17:00. Similarly, the user of using end 14b transmitted an official leave application (event information B) at 10:00. At that time, the event information B was transmitted to the mailing system 16, and the e-form system 18 classified and stored the contents and the transmitting time of the event information B. Because the e-form system 18 identified the priority of the event information B as “medium”, and we assume the e-form system 18 transmits low-priority event information at 12:00 every noon or at 17:00 every afternoon so that the timing of transmitting event information B was set as 12:00. The user of using end 14c felt sick and transmitted a sick leave application (event information C) at 10:00. The e-form system 18 identified the priority of the event information C as “medium” so that the timing of transmitting event information B was set as 12:00. The user of using end 14d transmitted an emergency message to the manager of the managing end 12 for approving (event information D), the e-form system 18 identified the priority of the event information D as “high”, and we assume the e-form system 18 transmits high-priority event information immediately so that the timing of transmitting event information A was set as transmitting immediately. The user of the using end 14e transmitted a resignation form at 13:20 in the afternoon (event information E). The e-form system 18 identified the priority of the event information E as “low” so that the timing of transmitting event information B was set as 17:00. The user of using end 14f transmitted an application of purchasing 100 packages of printer papers at 13:30 (event information F), the e-form system 18 identified the priority of the event information F as “low” so that the timing of transmitting event information F was set as 17:00. The user of using end 14g transmitted an application of a product developing meeting starting in 15 minutes to the managing end 12 at 14:45 (event information G) because customers discovered problems with the products. The e-form system 18 identified the priority of the event information G as “high” so that the timing of transmitting event information G was set as transmitting immediately. The user of using end 14h transmitted an application for wedding leave at 18:00 (event information H) and the priority of the event information H as “medium” so that the timing of transmitting event information H was set as 12:00 noon of the following day.

The above-mentioned event information all need to be approved by the manager. But not all the event information need to be processed immediately. Parts of the event information have to be approved through a discussion of managers. For example, for event information A, the cost of 30 LCD displays may be too much, the manager of managing end 12 has to ask the boss, or may have to compare with other prices. So, the event information A cannot be processed immediately. For event information B, the official leave request has been determined before, and the manager only has to approve it nominally. So, event information B does not need to be processed immediately. For event information C, the user of using end 14c may need to go see a doctor first, and the manager of managing end 12 only has to approve the sick leave request later. So, event information C does not need to be processed immediately. But for event information D and G, the two event information both need to be processed immediately. As mentioned above, the priorities of all event information are quite different. And therefore, the e-form system 18 analyzes the priorities of all the event information and identifies different timings of transmitting the event information according to the priorities of the event information.

Please refer to the FIGS. 1, 2, 5, and 6. How the managing end 12 receives the event information is illustrated as follows. From the FIGS. 1, 2, and 5, it is easily seen that even though event information A, B, C are transmitted earlier than the event information D, but the priority of the event information D is high. So, after the using end transmitted the event information D, through the analysis of e-form system 18, the e-form system 18 identified the timing of transmitting the event information D as “immediately”. Therefore the mailing system 16 immediately transmitted the event information D to the managing end 12. And after the managing end 12 received the event information D, the managing end could immediately process the event information D and transmit the result to the using end 14d and the related staff. And then, the e-form system 18 notified the mailing system 16 to transmit the event information B, C to managing end 12 at 12:00, and the managing end transmitted the result back to the using end 14b, 14c. Please note that the event information A is still stored in the e-form system 18 and has not been transmitted to the managing end 12 yet. In the afternoon, due to the e-form system 18 identifying the priority of the event information G as high, the e-form system 18 identified the timing of transmitting the event information G as “immediately”. So the managing end 12 received the event information G immediately. Besides, the event information E and F are stored until 17:00. But because that the event information A, G are about purchasing, for distinguishing the two event information A, G from other event information (such as event information E), the two event information A, G are transmitted to the managing end 12 at the same time or firstly combined into a new event information and then transmitted to the managing end 12. Furthermore, although the priority of the event information H is “medium”, the event information H is transmitted to the managing end at 12:00 during the next day because the event information H is transmitted by the using end later than the transmitting timing 17:00.

The priorities of the event information and the corresponding transmitting timings can be adjusted by designers. For example, we can identify the priority of an application which applies to less than a first dollar amount as lower, and the priority of an application which applies more than a second dollar amount as higher. And the transmitting timing can be set as every hour or at a certain time such as 14:00 every afternoon. Absolutely, the condition of the priority is not limited to the contents of the event information. Any other conditions can be used, such as the status of who transmits the event information. Furthermore, the priority of the event information is not limited to be judged by the e-form system 18, for example, the user of using end 14c can change the event information C to be high-priority so that the timing of transmitting the event information is set as “immediately”.

Please note that the present invention mailing system 16 can utilize the Microsoft® Outlook® mailing system or other software products. Therefore, every time the using end 14 transmits a request, the managing end 12 responds, or the mailing system 16 and the e-form system execute related processing of the event information. The mailing system 16 can automatically generate a copy (or notifying information), so the using ends 14a-14h can backup this important information.

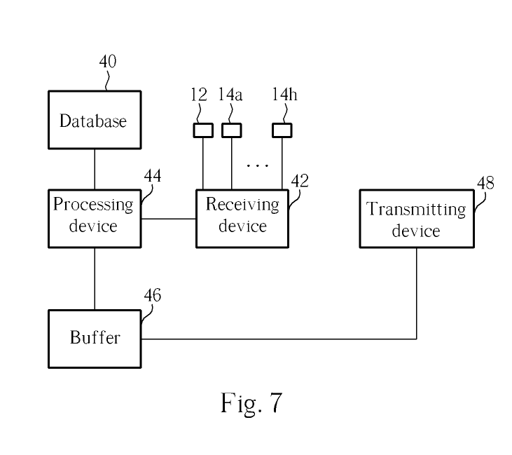

The present invention provides an e-form system of managing event information. As shown in FIG. 7, the e-form system comprises a database 40 for storing rules for identifying a priority of event information and rules for setting a transmitting timing according to different priorities, a receiving device 42 for receiving the event information from the using ends 14a-14h and the managing end 12, a processing device 44 for analyzing contents of the event information and setting the transmitting timing according to the contents and the database, a buffer 46 for storing the event information before the transmitting timing, and a transmitting device 48 for transmitting the event information at the transmitting timing. Comparing FIG. 7 with FIG. 1, the transmitting device 48 corresponds to the mailing system 16, and the database 40, receiving device 42, processing device 44, and the buffer all correspond to the e-form system 18. Here, the transmitting device 42 (or mailing system 16) can be any of e-mail system which is capable of arranging schedules, setting an e-mail to be transmitted at the transmitting timing, and transmitting the e-mail at the transmitting timing. The contents of the database 40 can be predetermined or can be adjusted according to users' needs. The receiving device 42 and the buffer 46 can be any type of memory which is capable of storing event information. The processing device 44 can be a hardware circuit, a VLSI circuit, firmware, or software which is capable of analyzing the contents of the event information and determining the priority of the event information according to the database 40. Because the prior art teaches us about analyzing keywords of the title, sender, contents of the e-mail (such as firewall or filter software) and classifying the event information according to the keywords (such as the help function of the computer software), the processing device 44 is easily used in actual implementation, and thus omitted here.

In contrast to the prior art, the present invention can respectively record and analyze the event information from different using ends and identify the transmitting timing according to the priority of each event information. Additionally, the present invention can classify the event information which does not need to be transmitted immediately and transmit event information whose transmitting timings are the same at the transmitting timing. Therefore, the e-form system according to the present invention analyzes the priority of each event information such as the title, the keywords of contents, the status of users, the predetermined priority set by using ends, or the predetermined priority set by the managing end so that the managers can deal with less important event information at a fixed timing instead of being disturbed all the time. Besides, the event information corresponding to similar classes are transmitted to the managing end so that the manager can deal with all the event information efficiently. To sum up, the present invention can raise the working efficiency of the manager.

Those skilled in the art will readily observe that numerous modifications and alterations of the device may be made while retaining the teachings of the invention. Accordingly, the above disclosure should be construed as limited only by the metes and bounds of the appended claims.

1. A method of managing event information comprising:
(a) receiving event information;
(b) identifying a priority of the event information;
(c) setting a timing of transmitting the event information according to the priority of the event information; and
(d) transmitting the event information at a time indicated by the timing.

2. The method of claim 1, wherein if the priority of the event information belongs to the class of immediate transmittal, transmitting the event information with other event information in the same class according to the timing settings.

3. The method of claim 1, wherein if the priority of the event information does not belong to the class of immediate transmittal, transmitting the event information is transmitted with other event information which is set to be transmitted at the same time.

4. The method of claim 1, further comprising:
generating a first notifying information to the source of the event information for notifying the source that the event information is received.

5. The method of claim 1, further comprising:
generating a second notifying information to the source of the event information for notifying the source of the process of the event information.

6. The method of claim 5, wherein the second notifying information at least indicates the transmitting time of the event information.

7. The method of claim 1 further comprising:
generating a third notifying information to the source for notifying the source of the process of the event information.

8. The method of claim 7, wherein the third notifying information at least comprises: the event information is received by a predetermined handler.

9. The method of claim 7, wherein the third notifying information at least comprises related information after the event information is processed by the predetermined handler.

10. The method of claim 1, wherein the step (b) identifies the priority of the event information according to an electronic form system.

11. The method of claim 1, wherein the step (c) sets the time indicated by the timing according to an electronic form system.

12. An electronic managing system of managing event information comprising:
a database for storing rules for identifying a priority of event information and rules for setting transmitting timing according to different priorities;
a receiving device for receiving the event information;
a processing device for analyzing contents of the event information and setting the transmitting timing according to the contents and the database;
a buffer for storing the event information before the transmitting timing; and
a transmitting device for transmitting the event information at a time indicated by the transmitting timing.

13. The electronic managing system of claim 12 wherein the transmitting device is an e-mail system capable of arranging schedules, setting an e-mail to be transmitted at the time indicated by the transmitting timing, and transmitting the e-mail at the time indicated by the transmitting timing.

14. The electronic managing system of claim 13 wherein the processing device is capable of generating a copy of the e-mail and transmitting the copy of the e-mail to the source of the event information through the transmitting device.

15. The electronic managing system of claim 14 wherein determining whether to generate the copy of the e-mail is decided according to one or more than one of the following conditions:
(a) notifying that the event information is received after receiving the event information;
(b) notifying that the transmitting timing is set;
(c) notifying that the event information is transmitted to a predetermined handler; and
(d) notifying the predetermined handler of the process of the event information.
